(19) United States
(12) Patent Application Publication
(10) Pub. No.: US 2025/0317409 A1
(43) Pub. Date: Oct. 9, 2025

(54) SYSTEM AND METHOD FOR PERFORMING VEHICLE OPERATIONS USING MESSAGE PLATFORM

(71) Applicant: FCA US LLC, Auburn Hills, MI (US)

(72) Inventors: Lucas Romero, St. Clair Shores, MI (US); Srihari Thirumoorthi, Coimbatore (IN); Nishant Garg, Bhilai (IN); Alan Cea, Austin, TX (US)

(21) Appl. No.: 18/625,249

(22) Filed: Apr. 3, 2024

(51) Int. Cl. H04L 51/046; H04L 51/21

(52) U.S. Cl. CPC H04L 51/046; H04L 51/21

(57) ABSTRACT

An instant messaging integration platform that communicates with an instant messaging application is disclosed. The instant messaging integration platform is configured for use with a vehicle and includes a computing device including one or more processors that perform operations. The operations include: receive, at the instant messaging integration platform a message from the instant messaging application, indicative of a vehicle request; evaluate, at the instant messaging integration platform, the message; authenticate, at a vehicle application programming interface, the vehicle for implementation of the request; execute, on the authenticated vehicle, the request; and deliver, from the instant messaging integration platform and to the instant messaging application, a confirmation of the executed request.

### FIELD

The present application relates generally to a vehicle messaging system configured to send and receive secure vehicle commands and data using third party messaging applications.

### BACKGROUND

Many vehicles have the ability for activating vehicle functions remotely (e.g., vehicle starting, unlocking, etc.) such as with a key fob or using a smart device (e.g., a smart phone) equipped with a dedicated vehicle application that remotely links the smart device with the vehicle. Dedicated vehicle applications can be difficult to use and become acquainted with. In addition, sometimes these vehicle specific applications are unavailable. Other methods for remote communication with a vehicle include cloud portals that allow users to remotely access their vehicles from any internet connected device. However, cloud portals can be slow and are not always secure. In this regard, the user must have an understanding on how to use such vehicle specific applications or cloud portal. This requirement may not be convenient for all users and lacks a personalized user experience.

Accordingly, while such remote access tools for communicating with a vehicle do work for their intended purpose, there is a desire for improvement in the relevant art.

### SUMMARY

In accordance with one example aspect of the invention, an instant messaging integration platform that communicates with an instant messaging application is disclosed. The instant messaging integration platform is configured for use with a vehicle and includes a computing device including one or more processors, a communication device for communication with a secure server via a network, and a non-transitory computer-readable storage medium having a plurality of instructions stored thereon, which, when executed by the one or more processors, cause the one or more processors to perform operations. The operations include: receive, at the instant messaging integration platform, a message, from the instant messaging application, indicative of a vehicle request; evaluate, at the instant messaging integration platform, the message; authenticate, at a vehicle application programming interface, the vehicle for implementation of the request; execute, on the authenticated vehicle, the request; and deliver, from the instant messaging integration platform and to the instant messaging application, a confirmation of the executed request.

In addition to the foregoing, the one or more processors further: receive the message at an original equipment manufacturer (OEM) cloud.

In addition to the foregoing, the one or more processors further: receive the message at the OEM cloud from a third party cloud associated with the instant messaging application.

In other examples, the message received at the instant messaging integration platform comprises a text.

In other examples, the message received at the instant messaging integration platform comprises a voice message.

In other examples, the message received at the instant messaging integration platform comprises an image.

In other examples, the message received at the instant messaging integration platform comprises a video.

In accordance with another example aspect of the invention, the instant messaging integration platform includes a secure application programming interface (API) that communicates requests and responses between a vehicle API and authenticates an authorized user of the instant messaging application with the vehicle.

In accordance with one example aspect of the invention, a method of using an instant messaging integration platform that communicates with an instant messaging application is provided. The instant messaging integration platform is configured for use with a vehicle and comprising a computing device, including one or more processors, a communication device for communication with a secure server via a network, and a non-transitory computer-readable storage medium having a plurality of instructions stored thereon, which, when executed by the one or more processors, cause the one or more processors to perform operations, the method comprises: receiving, at the instant messaging integration platform, a message, from the instant messaging application, indicative of a vehicle request; evaluating, at the instant messaging integration platform, the message; authenticating, at a vehicle application programming interface, the vehicle for implementation of the request; executing, on the authenticated vehicle, the request; delivering, from the instant messaging integration platform and to the instant messaging application, a confirmation of the executed request.

In other examples, the method comprises: receiving the message at an original equipment manufacturer (OEM) cloud.

In other examples, the method comprises: receiving the message at the OEM cloud from a third party cloud associated with the instant messaging application.

In other examples, the message received at the instant messaging integration platform comprises a text.

In other examples, the message received at the instant messaging integration platform comprises a voice message.

In other examples, the message received at the instant messaging integration platform comprises an image.

In other examples, the message received at the instant messaging integration platform comprises a video message.

In other examples, the instant messaging integration platform includes a secure application programming interface (API). The method further comprises: communicating requests and responses between a vehicle API; and authenticating an authorized user of the instant messaging application with the vehicle.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a diagram of an example vehicle messaging system in accordance with the principles of the present application; and

FIG. 2 is a functional block diagram of method of using the vehicle messaging system of FIG. 1, in accordance with the principles of the present application.

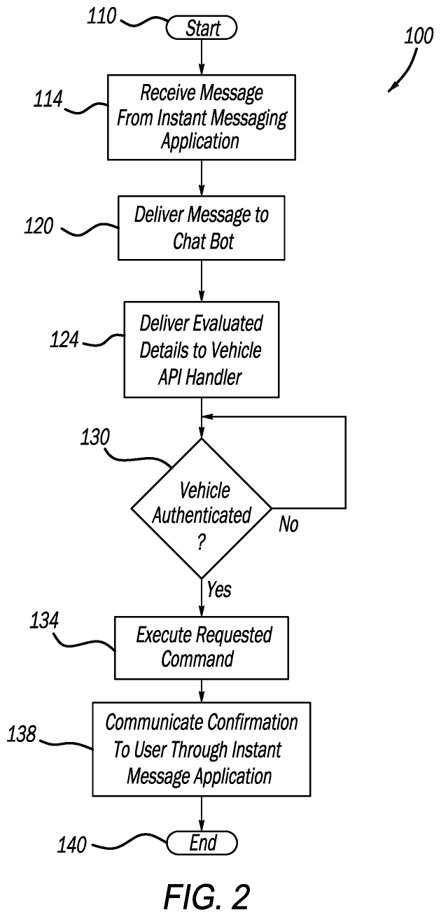

### DETAILED DESCRIPTION

As previously discussed, many vehicles have the ability for remote operations such as with a key fob or using a smart device (e.g., a smart phone) equipped with a vehicle application (mobile application) that remotely links the smart device with the vehicle. By way of example, such remote operations can include lock, unlock, start, parameter verification (fuel level), etc. Traditional methods of using such smart devices require a dedicated vehicle specific application or a cloud portal. Dedicated vehicle applications and cloud portals can be difficult to use, especially for users who are not familiar with the technology. In this regard, the user must have an understanding on how to use such vehicle specific applications or cloud portals. In some instances, network bandwidth can only provide limited connectivity. Dedicated vehicle applications and cloud portals may not allow users to personalize their vehicles. The cost of operating such platforms can be significant for the vehicle manufacturer and requires regular maintenance. This requirement may not be convenient for all users and lacks a personalized user experience.

Accordingly, the present disclosure provides a vehicle messaging system and method that leverages known instant messaging (IM) and voice-over-IP (VOIP) applications to communicate with the vehicle. By way of example, the instant disclosure describes using the instant messaging application WhatsApp®, however other instant messaging applications, such as, but not limited to, iMessage®, WeChat®, Facebook® messenger, Instagram® direct messaging, and others are contemplated within the scope of the present disclosure. The example instant messaging application described herein is a widely used and commonly available messaging platform. In this regard, users are already familiar with how to use it. Further, by using text or chat with the example instant messaging application (WhatsApp®), it is easy for users to remotely communicate with their vehicles without having to download a separate application. The interaction between a user and their vehicle can be conversational in nature (as opposed to traditional impersonal methods such as clicking an icon). In this regard., it is further contemplated that additional context can be added by the user in the text or chat to the vehicle that can include conversational phrases or commands such as “can you start my car”, or “please start my car at 6:00 tomorrow morning”.

As will become appreciated herein, the instant disclosure uses secure application programming interfaces (API's) to ensure that only the authorized user can control the vehicle. This prevents unauthorized parties from accessing the vehicle. The instant disclosure allows users to personalize their vehicles by naming them and interacting with them in a natural way, making the system more engaging and fun to use. The instant disclosure allows remote commands to be deployed to users in shorter software development life cycles. As such, there is no need to update any dedicated application or cloud portal to use new remote commands.

The instant vehicle messaging system provides advantages over previous solutions in that it provides convenience, personalization and faster development with shorter cycles, and is cost effective. The instant vehicle messaging system is more convenient than dedicated vehicle applications and cloud portals because it leverages known instant messaging applications (e.g., WhatsApp®), which is widely used and commonly available instant messaging platform. The instant vehicle messaging system allows users to personalize their vehicles (such as assign specific names), which is not possible with dedicated applications or cloud portals. For example, and as discussed herein, a user may assign a name to their vehicle such as “REVM”. The user can send a message (through the instant messaging application) such as “start REVM” to start the vehicle engine, or “lock REVM” to lock the doors.

The instant vehicle messaging system allows deploying new remote commands to users in shorter amounts of time. The instant vehicle messaging system does not require updates to dedicated vehicle applications or cloud portals. It is unnecessary to update and download latest versions of dedicated vehicle applications. The instant vehicle messaging system is API centric, which allows it to be device and operating system agnostic. Only one development team is required to maintain the API's, which can be integrated into any number of applications and services.

The instant messaging system includes several security features to ensure that it can only be used by authorized users. In particular, these features include authentication, encryption and authorization. The user must authenticate themselves to the vehicle before they can send commands. The commands are encrypted to prevent unauthorized parties from reading them. The commands are authorized by the vehicle before they are executed.

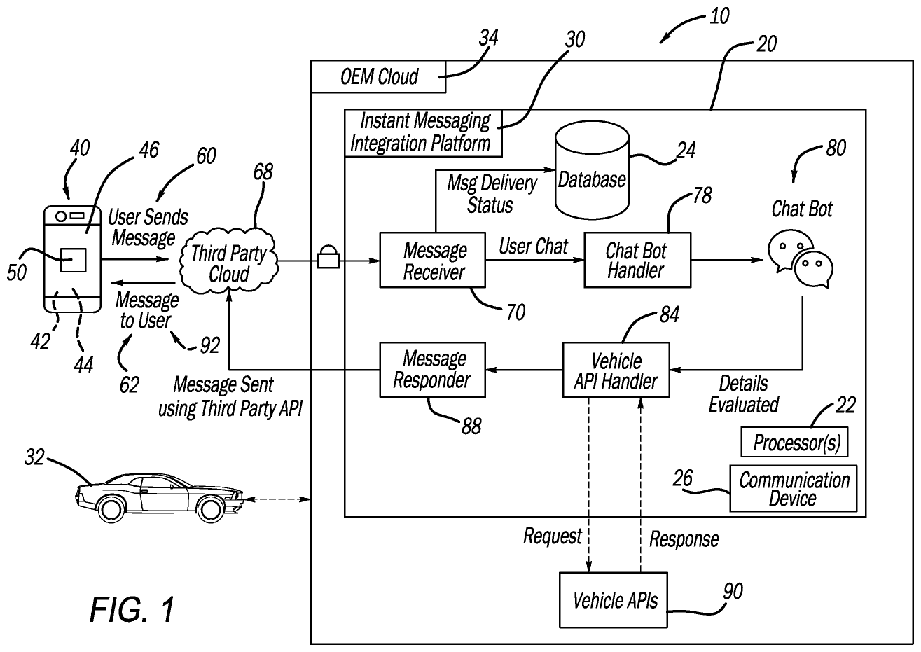

With reference now to FIG. 1, a diagram of an example vehicle messaging system or platform 10 is illustrated in accordance with the principles of the present disclosure. The example vehicle messaging system 10 includes a computing device 20 that executes an instant messaging integration platform 30 for performing commands on a vehicle 32. The computing device 20 can include one or more processors 22, a database 24, and a communication device 26.

The instant messaging integrated platform 30 can be communicated with through an original equipment (OEM) cloud 34. A mobile computing device 40 can include one or more processors 42, a memory 44, and a display device 46. The mobile computing device 40 is configured to operate an instant messaging application 50 (e.g., WhatsApp®). The mobile computing device 40 can run the instant messaging application 50 to send messages 60 and receive messages 62 to the OEM cloud 34 through an instant messaging application third party cloud 68.

The instant messaging integration platform 30 includes a message receiver 70, the database 24, a chat bot handler 78, a chat bot 80, a vehicle API handler 84, and a message responder 88. The vehicle API handler 84 communicates requests and responses between vehicle API's 90.

The mobile computing device 40 can communicate the messages 60, 62 to the OEM cloud 34 and/or the third party cloud 68 through a network 92 that can be any suitable communication network including, for example, a satellite network, a cellular network (3G, 4G LTE, 5G, etc.), a computing network (local area network, the internet, etc.), or some combination thereof.

In the example embodiment, the processors 22 are configured to control operation of the computing device 20. The term “processor” as used herein can refer to both a single processor and two or more processors operating in a parallel or distributed architecture. The database or memory 24 can be any suitable storage medium (flash, hard disk, etc.) configured to store information at the computing device 20. In one implementation, the memory 24 is a non-transitory computer-readable storage medium configured to store instructions executable by the processors 22 to cause the computing device 20 to perform at least a portion of the disclosed techniques.

An example computer-implemented method 100 for using the vehicle messaging system 10 will be described. The method begins at step 110. At step 114, the computing device 20 receives a message from the instant messaging application 50. The message can be a text, a voice message, an image, a video message or other message indicative of a request by the user to perform an action related to the vehicle 32. At 120, the computing device 20 delivers the message to the chat bot 80. At 124, the computing device 20 delivers evaluated details to the vehicle API handler 84 that communicates requests and responses between a vehicle API 90. At 130, the computing device 20 determines whether the vehicle is authenticated. If not, control loops to 130. If the vehicle 32 is authenticated at 130, the computing device 20 executes the requested command at 134. Again, the executed command can include any command requested by the user and sent through the instant messaging application 50 such as “lock my car”. At 138, the computing device 20 communicates a confirmation to the user through the instant messaging application 50. The method ends at 140.

The methods and systems described herein with respect to the instant messaging integration platform 30 may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other types of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, Internet server, intranet server, cloud server, and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server. In embodiments, the server may be a virtual machine that is executed by a processing system of a cloud-services platform (e.g., Amazon® AWS). In these embodiments, the cloud-services platform may offer computing resources that host and support various aspects of a third-party's software systems.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, Internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code, and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, and instructions described herein and elsewhere may be executed by one or more of the network infrastructural elements. The methods and systems described herein may be adapted for use with any kind of private, community, or hybrid cloud computing network or cloud computing environment, including those that involve features of software as a service (Saas), platform as a service (PaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or intangible items from one state to another. The methods and systems described herein may also transform data representing physical and/or intangible items from one state to another.

The elements described and depicted herein, including in flowcharts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flowchart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium. The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

The use of the terms “a” and “an” and “the” and similar referents in the context of describing the disclosure (especially in the context of the following claims) is to be construed to cover both the singular and the plural unless otherwise indicated herein or clearly contradicted by context. The terms “comprising,” “having,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the foregoing written description enables one skilled in the art to make and use what is considered presently to be the best mode thereof, those skilled in the art will understand and appreciate the existence of variations, combinations, and equivalents of the specific embodiment, method, and examples herein. The disclosure should therefore not be limited by the above-described embodiment, method, and examples, but by all embodiments and methods within the scope and spirit of the disclosure.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An instant messaging integration platform that communicates with an instant messaging application, the instant messaging integration platform configured for use with a vehicle and comprising:
a computing device, including one or more processors, a communication device for communication with a secure server via a network, and a non-transitory computer-readable storage medium having a plurality of instructions stored thereon, which, when executed by the one or more processors, cause the one or more processors to perform operations including:
receive, at the instant messaging integration platform, a message, from the instant messaging application, indicative of a vehicle request;
evaluate, at the instant messaging integration platform, the message;
authenticate, at a vehicle application programming interface, the vehicle for implementation of the request;
execute, on the authenticated vehicle, the request; and
deliver, from the instant messaging integration platform and to the instant messaging application, a confirmation of the executed request.

2. The instant messaging integration platform of claim 1, wherein the one or more processors further:
receive the message at an original equipment manufacturer (OEM) cloud.

3. The instant messaging integration platform of claim 2, wherein the one or more processors further:
receive the message at the OEM cloud from a third party cloud associated with the instant messaging application.

4. The instant messaging integration platform of claim 3, wherein the message received at the instant messaging integration platform comprises a text.

5. The instant messaging integration platform of claim 3, wherein the message received at the instant messaging integration platform comprises a voice message.

6. The instant messaging integration platform of claim 3, wherein the message received at the instant messaging integration platform comprises an image.

7. The instant messaging integration platform of claim 3, wherein the message received at the instant messaging integration platform comprises a video message.

8. The instant messaging integration platform of claim 1, wherein the instant messaging integration platform includes a secure application programming interface (API) that communicates requests and responses between a vehicle API and authenticates an authorized user of the instant messaging application with the vehicle.

9. A method of using an instant messaging integration platform that communicates with an instant messaging application, the instant messaging integration platform configured for use with a vehicle and comprising a computing device, including one or more processors, a communication device for communication with a secure server via a network, and a non-transitory computer-readable storage medium having a plurality of instructions stored thereon, which, when executed by the one or more processors, cause the one or more processors to perform operations, the method comprising:
receiving, at the instant messaging integration platform, a message, from the instant messaging application, indicative of a vehicle request;
evaluating, at the instant messaging integration platform, the message;
authenticating, at a vehicle application programming interface, the vehicle for implementation of the request;
executing, on the authenticated vehicle, the request; and
delivering, from the instant messaging integration platform and to the instant messaging application, a confirmation of the executed request.

10. The method of claim 9, further comprising:
receiving the message at an original equipment manufacturer (OEM) cloud.

11. The method of claim 10, further comprising:
receiving the message at the OEM cloud from a third party cloud associated with the instant messaging application.

12. The method of claim 11, wherein the message received at the instant messaging integration platform comprises a text.

13. The method of claim 11, wherein the message received at the instant messaging integration platform comprises a voice message.

14. The method of claim 11, wherein the message received at the instant messaging integration platform comprises an image.

15. The method of claim 11, wherein the message received at the instant messaging integration platform comprises a video message.

16. The method of claim 9, wherein the instant messaging integration platform includes a secure application programming interface (API), the method further comprising:
communicating requests and responses between a vehicle API; and
authenticating an authorized user of the instant messaging application with the vehicle.
